(19) United States
(12) Patent Application Publication
(10) Pub. No.: US 2020/0267502 A1
(43) Pub. Date: Aug. 20, 2020

(54) SELF-LOCATION ESTIMATION METHOD FOR A MOVEABLE OBJECT AND MOVEABLE OBJECT USING THE SAME

(71) Applicants: INDUSTRY-ACADEMIC COOPERATION FOUNDATION, YONSE UNIVERSITY, Seoul (KR); KOREA UNIVERSITY RESEARCH AND BUSINESS FOUNDATION, Seoul (KR)

(72) Inventors: Sang Hyun LEE, Busan (KR); Hee Soo KIM, Busan (KR); Kwang Soon KIM, Seoul (KR); Dong Ku KIM, Seoul (KR)

(21) Appl. No.: 16/478,228

(22) PCT Filed: Dec. 21, 2017
(86) PCT No.: PCT/KR2017/015289

§ 371 Date: Jul. 16, 2019

(30) Foreign Application Priority Data
Nov. 16, 2017 (KR) 10-2017-0152936

(51) Int. Cl. H04W 4/02; H04W 4/029; H04W 4/44; H04W 64/00

(52) U.S. Cl. CPC H04W 4/026; H04W 64/006; H04W 4/44; H04W 4/029

(57) ABSTRACT

The present invention relates to a method by which a movable object that is within a wireless network and capable of communicating with other movable objects uses the relative distance and azimuth angle information of the movable objects to estimate its self-location, as well as to the movable object capable of estimating its self-location. A self-location estimation method according to an embodiment of the present invention can be a method used by a movable object within a wireless network environment that enables communication between movable objects and can include: receiving the location information of a counterpart movable object from the counterpart movable object; measuring the relative distance and relative azimuth angle of the counterpart movable object; and deriving the current location information of the movable object by using the received location information of the counterpart movable object and the measured relative distance and relative azimuth angle.

### CROSS-REFERENCE TO RELATED APPLICATIONS

This application is a National Phase Application of PCT International Application No. PCT/KR2017/015289, which was filed on Dec. 21, 2017, and which claims priority from Korean Patent Application No. 10-2017-0152936 filed with the Korean Intellectual Property Office on Nov. 16, 2017. The disclosures of the above patent applications are incorporated herein by reference in their entirety.

### BACKGROUND

### 1. Technical Field

The present invention relates to a self-location estimation method for a movable object and to a movable object using the same, more particularly to a method by which a movable object that is within a wireless network and capable of communicating with other movable objects uses the relative distances and azimuth angles of the movable objects to estimate its self-location, as well as to the movable object capable of estimating its self-location.

### 2. Description of the Related Art

Whereas previous forms of radio communication technology were utilized for communication or information transfer purposes between persons, current trends see this technology expanding in its range of application to communications between persons and objects and between objects and objects. In particular, there are rapid movements towards forming networks between vehicles and humans, between vehicles and vehicles, and between vehicles and traffic infrastructure. Accordingly, the radio communication market is focusing its attention on the so-called V2X technology, which includes for example V2V (vehicle-to-vehicle), V2I (vehicle-to-infrastructure), and V2N (vehicle-to-nomadic devices) communication. The related prior art includes Korean Patent Publication No. 2017-0071207.

As an automobile is a movable object running on roads, there is a demand for technology that allows precision localization services for accurately recognizing self-location by using communication between road-side facilities (equipment) and the automobile. To achieve such localization with conventional localizing technologies, one would have to overcome the challenges of complicated computations and increased sizes of messages exchanged.

Thus, there is a need for research on a method of achieving distributed cooperative localization using minimal amounts of information exchange.

### SUMMARY OF THE INVENTION

An objective of the present invention is to provide a movable object capable of estimating self-location and a method of estimating self-location through a minimal amount of information exchange with a counterpart movable object.

An objective of the present invention is to provide a movable object and a method of estimating self-location for the movable object by which the movable object determines its current self-location by using information on the relative distance and relative azimuth angle of a counterpart movable object in an environment that allows communication between the movable objects.

To achieve the objectives above, an embodiment of the present invention provides a self-location estimation method used by a movable object within a wireless network environment that enables communication between movable objects, where the self-location estimation method includes: receiving the location information of a counterpart movable object from the counterpart movable object; measuring the relative distance and relative azimuth angle of the counterpart movable object; and deriving the current location information of the movable object by using the received location information of the counterpart movable object and the measured relative distance and relative azimuth angle.

To achieve the objectives above, an embodiment of the present invention provides a movable object capable of estimating self-location in a wireless network environment that enables communication with a counterpart movable object, where the movable object includes: a message receiver unit configured to receive the location information of the counterpart movable object from the counterpart movable object; a measurement unit configured to measure the relative distance and relative azimuth angle of the counterpart movable object; a current location determiner unit configured to derive the current location information of the movable object by using the received location information of the counterpart movable object and the measured relative distance and relative azimuth angle; and a control unit configured to control the message receiver unit, measurement unit, and current location determiner unit.

With a self-location estimation method for a movable object and a movable object using the method according to an embodiment of the present invention, it is possible for the movable object to estimate its self-location from a minimal amount of information exchange between movable objects.

A self-location estimation method for a movable object according to an embodiment of the present invention can be useful in forming networks between vehicles and humans, between vehicles and vehicles, and between vehicles and traffic infrastructure.

### BRIEF DESCRIPTION OF THE DRAWINGS

FIG. 1 is a diagram illustrating communication between movable objects within a wireless network in an example related to an embodiment of the present invention.

FIG. 2 is a diagram illustrating a method by which a movable object may estimate its self-location through a graph-based approach in an example related to an embodiment of the present invention.

FIG. 3 is a block diagram of a movable object in an example related to an embodiment of the present invention.

FIG. 4 is a flow diagram illustrating a self-location estimation method for a movable object in an example related to an embodiment of the present invention.

FIG. 5(a) and FIG. 5(b) are a diagram for describing a method of probabilistically approximating a location through a 2-dimensional coordinate model based on relative distance information and relative azimuth angle information in an example related to an embodiment of the present invention.

FIG. 6 is a graph representing driving results for movable objects obtained by using a self-location estimation method for a movable object in an example related to an embodiment of the present invention.

### DETAILED DESCRIPTION OF THE INVENTION

In the following, a self-location estimation method for a movable object and a movable object using the method related to certain embodiments of the present invention will be described, with reference to the accompanying drawings.

In the present specification, an expression used in the singular encompasses the expression of the plural, unless it has a clearly different meaning in the context. In the present specification, it is to be understood that terms such as “including” or “having”, etc., are intended to indicate the existence of the features, numbers, steps, actions, components, parts, or combinations thereof disclosed in the specification and are not intended to preclude the possibility that one or more other features, numbers, steps, actions, components, parts, or combinations thereof may exist or may be added.

In the embodiments below, a movable object refers to an object that moves and can include a vehicle.

In the context of self-localization, the members of a network may be divided into anchors, which are always aware of their locations, and agents, which are not aware of their locations. Cooperative localization can be achieved by way of measurements of relative distances to neighbors between an anchor and agents or by way of interactions for transferring such information. For example, a vehicle that is always aware of its location due to the aid of a base station or a GPS can be as an anchor, and a vehicle that is not aware of its location can be an agent.

Also, localization algorithms can be divided as follows.

First, the algorithms can be divided into centralized localization and distributed localization types. In a centralized type technique, the locations of all agents are determined solely at a center. That is, measurement results are collected from agents and anchors, and the locations of all agents are calculated simultaneously. The centralized type generally has a drawback in terms of scalability and thus is not a practical option for a large-scale network. In a distributed type technique, there is no central processing device, and therefore each of the agents has to identify its location using only the information that can be collected locally. However, even when the scale of a network is increased, the calculation load is not increased significantly, providing an advantage in terms of scalability and allowing easy application to a large-scale network.

Localization algorithms can also be divided into absolute localization and relative localization types. Absolute localization refers to localization within a single coordinate system provided beforehand. Conversely, relative localization refers to a method of achieving localization based on relationships with the surrounding environment and neighbors. Therefore, in relative localization, since each network object would have a different coordinate system, conversion or synchronization is essential.

Localization algorithms can also be divided into cooperative localization and non-cooperative localization. In non-cooperative localization, there is no communication between agents, and communication occurs only between the agents and the anchors. As each agent needs to communicate with multiple anchors, either the anchors must have a large communication range or a high density of anchors must be present. In cooperative localization, communication may occur between agents, so that there is no need to have many anchors around each agent. Thus, the density of anchors can be lowered, and there is no need to expand the communication ranges of the anchors. As each agent may communicate with other agents and anchors within its communication range, the level of accuracy can be improved.

In the following, a method by which a movable object estimates its self-location through distributed cooperative localization is described, as an embodiment of the present invention.

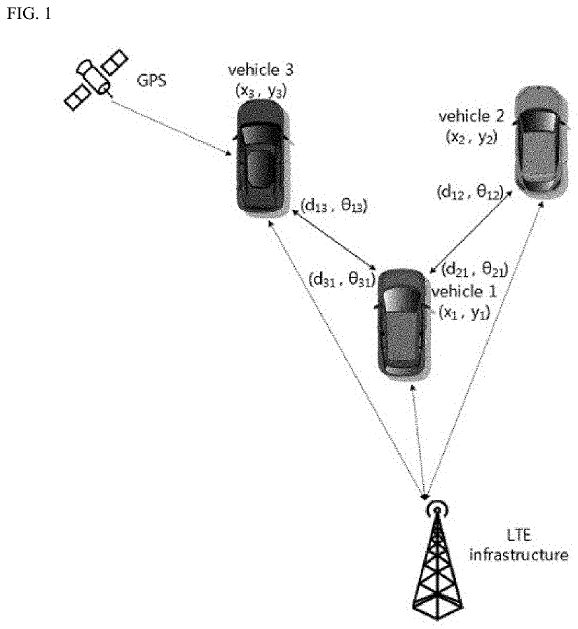

FIG. 1 is a diagram illustrating communication between movable objects within a wireless network in an example related to an embodiment of the present invention.

As illustrated in the figure, each of the movable objects (vehicle 1, vehicle 2, and vehicle 3) is capable of direct communication with other movable objects without depending on the infrastructure such as base stations, etc.

Also, each movable object (vehicle 1, vehicle 2, vehicle 3) can measure its approximate location and the distance and azimuth angle of another movable object (counterpart movable object) through appropriate means, where such information can be contaminated by noise. The appropriate means above can include means such as mmWave and lidar. Also, due to contamination, the distance and azimuth angle information measured by two movable objects may not be the same. In FIG. 1, (x,y) represents the location of each movable object in 2-dimensional coordinates, and (x₁,y₁) for example represents the location of Movable Object 1 (vehicle 1). Also, d and θ represent relative distance and azimuth angle, respectively. For example, d_{1,3} and θ_{1,3} represent the relative distance and relative azimuth angle of Movable Object 1 (vehicle 1) as measured by Movable Object 3 (vehicle 3).

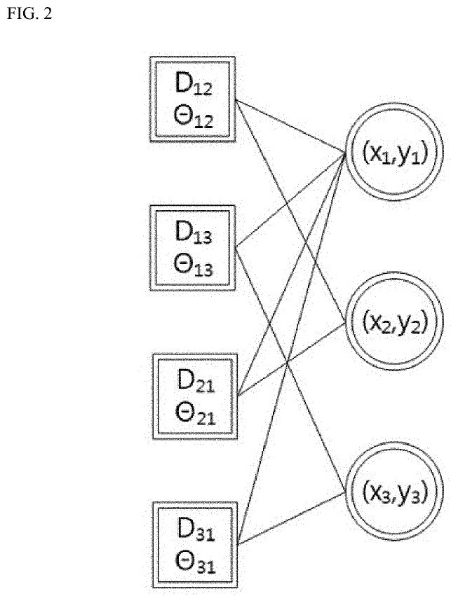

FIG. 2 is a diagram illustrating a method by which a movable object may estimate its self-location through a graph-based approach in an example related to an embodiment of the present invention.

As illustrated in the figure, in an environment such as that shown in FIG. 1, the distributed localization problem can be defined in a graph form by defining the connections of counterparts with which the measurement and exchange of information between movable objects is possible.

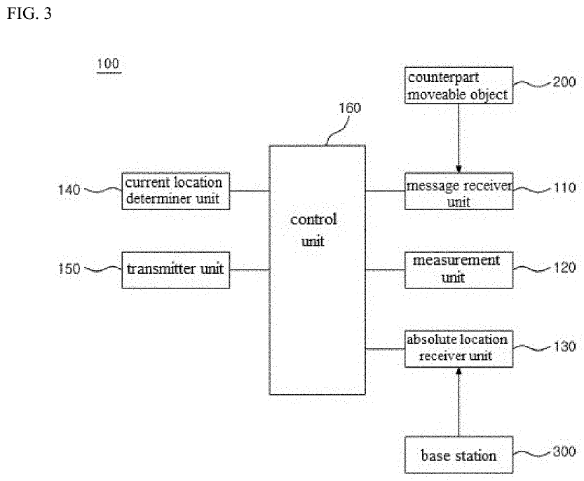

Using a graph to express the relationships between variables, which in many cases are determined by probability distributions, in order to resolve a complicated estimation problem, is referred to as graph modeling. This provides an estimation technique known as a message transfer method, in which the value of each variable associated with a probability distribution is predicted in a distributive, cooperative method from the probability distribution defining the graph. In most localization-related models, agents are capable of communicating with small numbers of nearby agents and anchors. Therefore, if each of the agents is expressed as a variable node, and if the communication relationships between nearby anchors and agents, information received by anchors or from other agents, and the like are expressed as function nodes, then the resulting graph may be represented as a comparatively sparse bipartite graph. FIG. 3 is a block diagram of a movable object in an example related to an embodiment of the present invention.

As illustrated in the figure, a movable object 100 can include a message receiver unit 110, a measurement unit 120, an absolute location receiver unit 130, a current location determiner unit 140, a transmitter unit 150, and a control unit 160. The movable object 100 may be an agent.

The message receiver unit 110 can receive the location information of a counterpart movable object in a message form from the counterpart movable object 200. The location information of a counterpart movable object can include the mean value and accuracy of the locations of the counterpart movable object. The accuracy can be expressed as a variance of the locations of the counterpart movable object.

The measurement unit 120 can measure the relative distance and relative azimuth angle of the counterpart movable object 200 by using a particular means. The particular means can include mmWave, lidar, etc.

The absolute location receiver unit 130 can receive the absolute location information of the movable object 100 from a base station 300.

The current location determiner unit 140 can derive the current location information of the movable object 100 by using the location information of the counterpart movable object (the mean value and accuracy of locations of the counterpart movable object) received from the counterpart movable object 200 and the obtained measurement information.

The transmitter unit 150 can broadcast the derived current location information of the movable object 100 in a message form without specifying the receiving target.

The control unit 160 can provide overall control of the message receiver unit 110, measurement unit 120, absolute location receiver unit 130, current location determiner unit 140, and transmitter unit 150.

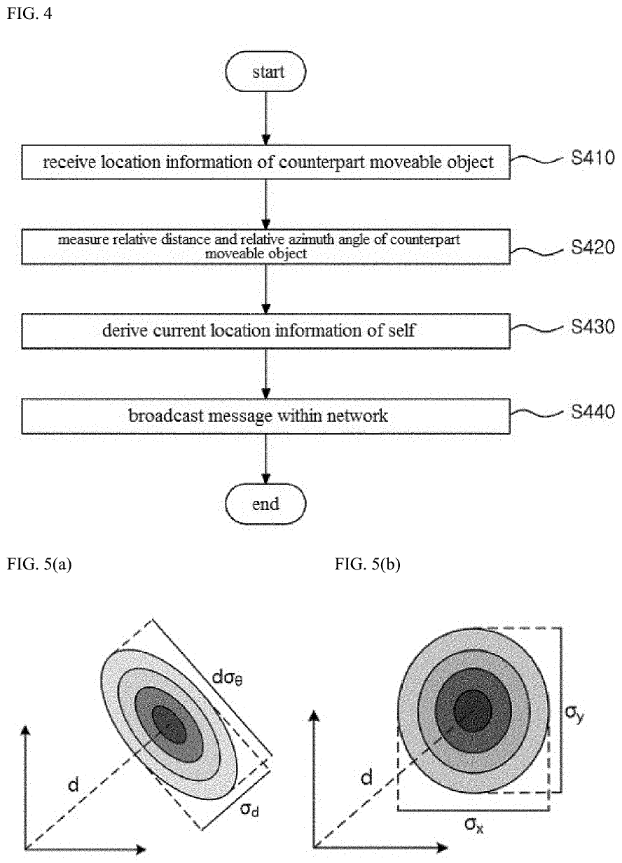

FIG. 4 is a flow diagram illustrating a self-location estimation method for a movable object in an example related to an embodiment of the present invention.

The message receiver unit 110 can receive the location information of a counterpart movable object in a message form from the counterpart movable object 200 (operation S410). The location information of a counterpart movable object can include the mean value and accuracy of the locations of the counterpart movable object. The accuracy can be expressed as a variance of the locations of the counterpart movable object.

The measurement unit 120 can measure the relative distance and relative azimuth angle of the counterpart movable object 200 by way of a means such as mmWave, lidar, and the like (operation S420).

The current location determiner unit 140 can derive the current location information of the movable object 100 by using the received location information of the counterpart movable object and the measured relative distance and relative azimuth angle (operation S430).

The relative distance and relative azimuth angle may be contaminated by noise, so that even though they may be defined with a probability distribution, the form may be considerably non-linear. Therefore, in the embodiment described below, a method of probabilistically approximating relative distance information and relative azimuth angle information through a 2-dimensional coordinate model can be used to derive the current location information of the movable object 100.

FIG. 5(a) and FIG. 5(b) are a diagram for describing a method of probabilistically approximating a location through a 2-dimensional coordinate model based on relative distance information and relative azimuth angle information in an example related to an embodiment of the present invention.

FIG. 5(a) represents a probability distribution plotted onto 2-dimensional coordinates for the relative distance and relative azimuth angle, while FIG. 5(b) represents an x,y coordinate model obtained by approximating the graph of FIG. 5(a). Here, it is supposed that the movable object 100 only has the relative distance and relative azimuth angle information of a counterpart movable object 200. Currently, there has as yet not been developed a simple method for estimating coordinates from a probability distribution having non-linear contours of an elliptical form. Thus, the distribution having contours shaped in the form of slanted ellipses can be approximated to a distribution for (x,y) that has a variance of the same magnitude. A normal distribution can be represented accurately if the mean and variance values are obtained.

By utilizing coordinate axis conversion and the Cauchy-Schwarz inequality, variance values σ_{X}² and σ_{Y}² can be approximated as shown below in Formula 1.

σₓ²≈σ_{d}² cos²θᵢⱼ^{(t}+(dᵢⱼ^{(t)})²σ_{θ}² sin²θᵢⱼ^{(t)}

σ_{y}²≈σ_{d}² sin²θᵢⱼ^{(t}+(dᵢⱼ^{(t)})²σ_{θ}² cos²θᵢⱼ^{(t)} [Formula 1]

Here, d and θ represent relative distance and azimuth angle, respectively. For example, d_{i,j} and θ_{i,j} represent the relative distance and relative azimuth angle of movable object i as measured by movable object j.

xₜ^{(t)}−xⱼ^{(t)}˜N(−dᵢⱼ^{(t)}cos θᵢⱼ^{(t)},σ_{d}² cos²θᵢⱼ^{(t)}+(dᵢⱼ^{(t)})²σ_{θ}² sin²θᵢⱼ^{(t)})

yₜ^{(t)}−yⱼ^{(t)}˜N(−dᵢⱼ^{(t)}sin θᵢⱼ^{(t)},σ_{d}² sin²θᵢⱼ^{(t)}+(dᵢⱼ^{(t)})²σ_{θ}² cos²θᵢⱼ^{(t)}) [Formula 2]

By utilizing the σ_{X}² and σ_{Y}² approximated above, the movable object (i,j) can estimate its own location to calculate a message, and from this message, the movable object j can calculate instantaneous estimates b^{(t)}(xₜ^{(t)}), b^{(t)}(yₜ^{(t)}) for a distributed localization of the current location, where the estimates can be expressed as a normal distribution.

It is supposed that, initially, each of the movable objects has partial information regarding its initial location. That is, it is supposed that the mean of the initial coordinates and the variance associated with the accuracy of the values are known. If such information is not known, it is possible to set the values to an arbitrary mean and a comparatively large variance. The mean values thus generated can be defined as mₓ_{ₜ}^{(t)}, m_{y}_{ₜ}^{(t)}, and the standard deviation values can be defined as σₓ_{ₜ}^{(t)}, σ_{y}_{ₜ}^{(t)}.

Since the probability distribution for relative distance and statistical values have been approximated to a normal distribution, the self-predicted values for location acquired from the received information can be shown as a normal distribution. This can be expressed as a sum of the observed values (relative distance and relative azimuth angle) observed by the movable object 100 and the received values (location information of the counterpart movable object).

Using Formula 2 above, the message transmitted by movable object i to movable object j can be expressed with respect to number of iterations 1 as Formula 3 below.

μ_{i→j}^{(t)}(xⱼ^{(t)})˜N(mₓ_{ₜ}^{(t-1)}+dᵢⱼ^{(t)}cos θᵢⱼ^{(t)},(σₓ_{ₜ}^{(t-1)})²+σᵢⱼ² cos²θᵢⱼ^{(t)}+(dᵢⱼ^{(t)})²σᵢⱼ² sin²θᵢⱼ^{(t)})

μ_{i→j}^{(t)}(yⱼ^{(t)})˜N(m_{y}_{ₜ}^{(t-1)}+dᵢⱼ^{(t)}cos θᵢⱼ^{(t)},(σₓ_{ₜ}^{(t-1)})²+σᵢⱼ² cos²θᵢⱼ^{(t)}+(dᵢⱼ^{(t)})²σᵢⱼ² sin²θᵢⱼ^{(t)}) [Formula 3]

Here, the mean and variance values may be provided as in Formula 4 shown below.

$$m \text{?} = ( σ \text{?} ) ( \frac{m \text{?}}{{( σ \text{?} )}^{2}} + {\sum }^{n} \text{?} \frac{m \text{?}}{{( σ \text{?} )}^{2}} ) \\ m \text{?} = {( σ \text{?} )}^{2} ( \frac{m \text{?}}{{( σ \text{?} )}^{2}} + {\sum }^{n} \text{?} \frac{m \text{?}}{{( σ \text{?} )}^{2}} ) \\ {( σ \text{?} )}^{2} = \frac{1}{( \frac{1}{{( σ \text{?} )}^{2}} + {\sum }^{n} \text{?} \frac{1}{{( σ \text{?} )}^{2}} )} \\ {( σ \text{?} )}^{2} = \frac{1}{( \frac{1}{{( σ \text{?} )}^{2}} + {\sum }^{n} \text{?} \frac{1}{{( σ \text{?} )}^{2}} )} \\ \text{?} \text{indicates text missing or illegible when filed} \qquad [ Formula 4 ]$$

Thus, the movable object 100 can broadcast its self-location information, derived as in Formula 4, in a message form within the network (operation S440).

Since the messages to be transmitted to nearby agents can also be approximated to expressions of a normal distribution, in practice, the movable objects can exchange only the means, variances, and simple parameters of the relative measurement results to achieve distributed localization. In addition, using the method of broadcasting for transferring the messages can further help to reduce communication loads.

As the broadcasting and updating procedures for the movable object 100 are iterated, the accuracy of the current location of the movable object 100 can be improved.

In one embodiment of the present invention, the movable object 100 can receive absolute location information from a base station 300 and use the information together when deriving its current location information. Utilizing absolute location information in this manner can aid the distributed cooperative localization.

According to one embodiment of the present invention, as the movable objects present within the network are mobile, the localization can be performed in designated intervals, and the location of each movable object can be updated according to the designated intervals.

To incorporate the updated location, each movable object can generate a probability distribution for the new location. That is, each movable object can determine a probability distribution for the new location by using the mean value and accuracy of the instantaneous measurements for the previous time and considering the instantaneous velocity.

As the mobility of the movable object is approximated to a normal distribution, a new location may be expressed with the next distribution, and the mean and variance values for the distribution can be used as the statistical values for cooperative localization at the corresponding time. By iterating these procedures for all times and all movable objects, the locations of all movable objects in the network can be determined by each movable object on its own. When the location of each movable object is updated by mobility as described above, the location can be expressed as Formula 5 shown below.

μₜ(xₜ^{(t+1)})˜N(mₓ_{ₜ}^{(t)}+vₓ_{ᵢ}^{(t)}Δtₜ,(σₓ_{ₜ}^{(t)})²+σ²)

μₜ(yₜ^{(t+1)})˜N(m_{y}_{ₜ}^{(t)}+v_{y}_{ᵢ}^{(t)}Δtₜ,(σ_{y}_{ₜ}^{(t)})²+σ²) [Formula 5]

Here, v refers to instantaneous velocity, t refers to the unit time interval in which the localization is performed, m refers to mean, and σ² refers to variance.

That is, the values for means mₓₜ^{(t)} and m_{yt}^{(t)} in Formula 4 may be calculated iteratively, and when the values converge, the results can be determined as the final values b^{(t)}(xₜ^{(t)}) and b^{(t)}(yₜ^{(t)}).

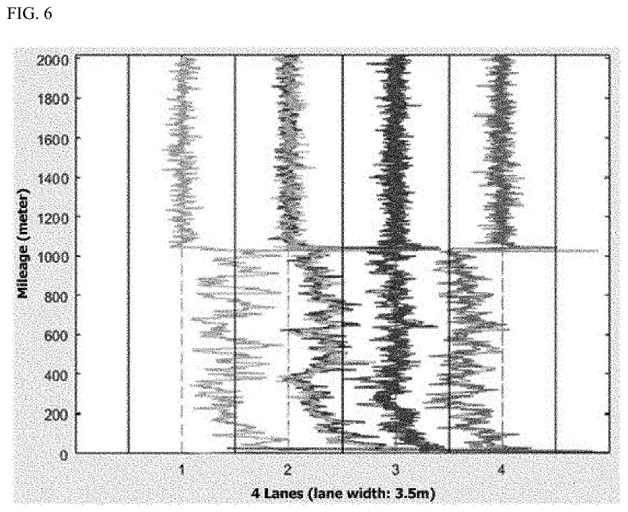

FIG. 6 is a graph representing driving results for movable objects obtained by using a self-location estimation method for a movable object in an example related to an embodiment of the present invention.

FIG. 6 shows the results of a simulated test obtained when using a method according to an embodiment of the present invention.

On a straight road having four lanes, ten vehicles are suitably distributed. The width of each lane is 3.5 meters, and the overall length of the straight road has been set to about 2000 meters. The mean velocity of each vehicle is 70 km/h, and the vehicles move from the bottom towards the top of the screen. Each of the vehicles measures its velocity every 100 ms and, in-between adjacent velocity measurement time points, performs a message exchange every 10 ms with vehicles that are within a relative distance of 50m for cooperative localization. Since in this environment each vehicle transmits a message that is common to all nearby vehicles, this corresponds to broadcasting the message every 10 ms. The information that can be measured or exchanged between vehicles includes the relative distance and azimuth angle between two vehicles capable of communication. The error for the relative distance was set to ±1 m, and the error for the azimuth angle was set to ±3°. It is assumed that all vehicles have information on their current locations at the initial starting time point and that the corresponding information has a normal distribution with a standard deviation of 1 m. Under these circumstances, the trajectories of the vehicles measured for 100 seconds while the vehicles move forward are as illustrated in FIG. 6.

The example above represents a case in which each of the vehicles is capable of using relative distance and azimuth angle information, and one of the vehicles is capable of periodically obtaining its absolute location. That is, the example presents a case in which just one vehicle acquires its absolute location from an LTE network or GPS, etc. It can be observed that very good results are obtained as regards the measurement results for the absolute locations of all of the vehicles. It can be observed that the error is roughly about 1 m, with a smaller error for the vehicle capable of acquiring its absolute location. The results above show that, with a minimal number of vehicles performing communication with the outside and with the vehicles performing measurements with respect to one another by way of mmWave, the vehicles can form a network and perform localization in a cooperative manner to improve the performance of the localization.

As presented above, with a self-location estimation method for a movable object and a movable object using the same, a movable object can estimate its self-location through an exchange of a minimal amount of information between movable objects.

A self-location estimation method for a movable object according to an embodiment of the present invention can aid the forming of networks between vehicles and humans, between vehicles and vehicles, and between vehicles and traffic infrastructure.

A self-location estimation method for a movable object described above can be implemented in the form of program instructions that may be performed using various computer means and can be recorded in a computer-readable medium. Here, such a computer-readable medium can include program instructions, data files, data structures, etc., alone or in combination. The program instructions recorded on the medium can be designed and configured specifically for the embodiments or can be a type of medium known to and used by the skilled person in the field of computer software.

A computer-readable medium may include a hardware device that is specially configured to store and execute program instructions. Some examples may include magnetic media such as hard disks, floppy disks, and magnetic tapes, optical media such as CD-ROM's and DVD's, magneto-optical media such as floptical disks, and hardware devices such as ROM, RAM, flash memory, SSD's (solid-state drives), etc., configured specially for storing and executing program instructions.

The recorded medium can also be a transmission medium, such as rays, metal lines, waveguides, etc., which may include carrier waves that transfer signals for specifying program instructions, data structures, etc.

Examples of the program of instructions may include not only machine language codes produced by a compiler but also high-level language codes that can be executed by a computer through the use of an interpreter, etc. The hardware mentioned above can be made to operate as one or more software modules that perform the actions of the embodiments, and vice versa.

A self-location estimation method for a movable object and the movable object using the method, disclosed above, are not limited in composition and method to the embodiments described above. Rather, elements of different embodiments can be wholly or partially combined in a selective manner to provide numerous variations.

What is claimed is:

1. A self-location estimation method for a movable object, the self-location estimation method used by the movable object within a wireless network environment enabling communication between movable objects, the self-location estimation method comprising:
receiving location information of a counterpart movable object from the counterpart movable object;
measuring a relative distance and a relative azimuth angle of the counterpart movable object; and
deriving current location information of the movable object by using the received location information of the counterpart movable object and the measured relative distance and relative azimuth angle.

2. The self-location estimation method for the movable object according to claim 1, further comprising:
broadcasting the derived current location information of the movable object in a message form.

3. The self-location estimation method for the movable object according to claim 1, further comprising:
receiving location information of an arbitrary movable object from the counterpart movable object, the location information of the arbitrary movable object having been previously received by the counterpart movable object.

4. The self-location estimation method for the movable object according to claim 1, wherein the location information of the counterpart movable object comprises a mean value of and an accuracy of a location of the counterpart movable object.

5. The self-location estimation method for the movable object according to claim 1, further comprising:
receiving absolute location information of the movable object from a base station,
wherein the deriving of the current location information of the movable object comprises deriving the current location information of the movable object by further using the received absolute location information.

6. A movable object capable of estimating self-location in a wireless network environment enabling communication with a counterpart movable object, the movable object comprising:
a message receiver unit configured to receive location information of the counterpart movable object from the counterpart movable object;
a measurement unit configured to measure a relative distance and a relative azimuth angle of the counterpart movable object;
a current location determiner unit configured to derive current location information of the movable object by using the received location information of the counterpart movable object and the measured relative distance and relative azimuth angle; and
a control unit configured to control the message receiver unit, the measurement unit, and the current location determiner unit.

7. The movable object of claim 6, further comprising a transmitter unit,
wherein the transmitter unit broadcasts the derived current location information of the movable object in a message form.

8. The movable object of claim 6, wherein the message receiver unit receives location information of an arbitrary movable object from the counterpart movable object, the location information of the arbitrary movable object having been previously received by the counterpart movable object.

9. The movable object of claim 6, wherein the location information of the counterpart movable object comprises a mean value of and an accuracy of a location of the counterpart movable object.

10. The movable object of claim 6, further comprising an absolute location receiver unit configured to receive absolute location information of the movable object from a base station,
wherein the current location determiner unit derives the current location information of the movable object by further using the received absolute location information.
